(19) United States
(12) Patent Application Publication
(10) Pub. No.: US 2026/0159385 A1
(43) Pub. Date: Jun. 11, 2026

(54) Hydrogen Manufacturing Apparatus, and Method for Manufacturing Hydrogen

(71) Applicants: Hyundai Motor Company, Seoul (KR); Kia Corporation, Seoul (KR)

(72) Inventors: Dong Seok Ko, Hwaseong-Si (KR); Jung Joo Park, Hwaseong-Si (KR); Jae Myung Lee, Hwaseong-Si (KR)

(21) Appl. No.: 19/245,754

(22) Filed: Jun. 23, 2025

(30) Foreign Application Priority Data
Dec. 10, 2024 (KR) 10-2024-018971

(51) Int. Cl. C01B 3/48

(52) U.S. Cl. CPC C01B 3/48; C01B 2203/0216; C01B 2203/1619; C01B 2203/1623; C01B 2203/169

(57) ABSTRACT

Disclosed are an apparatus for manufacturing hydrogen by using a vapor-methane reforming reaction, and a hydrogen manufacturing method using the same. The apparatus may include a reformer configured to generate, through a reaction of methane and water, a first gas, wherein the first gas comprises hydrogen and carbon monoxide; a water gas shift reactor configured to generate, through a reaction of the carbon monoxide in the first gas and of water, a second gas; and a processor configured to determine, based on a temperature of the second gas measured by a first temperature sensor, a methane shift rate in the reformer.

### CROSS-REFERENCE TO RELATED APPLICATION

This application claims the benefit of and priority to Korean Patent Application No. 10-2024-0182971, filed in the Korean Intellectual Property Office on Dec. 10, 2024, the entire contents of which are incorporated herein by reference.

### TECHNICAL FIELD

The present disclosure relates to a hydrogen manufacturing apparatus.

### BACKGROUND

Hydrogen gas has been in the spotlight as an eco-friendly energy source, and various methods of producing hydrogen gas have been proposed. Among the methods for producing hydrogen gas, a wet reforming method (also referred to as a steam methane reforming (SMR) method) of manufacturing hydrogen through a reaction of methane and water, and a dry reforming method (also referred to as a dry methane reforming (DMR) method) of manufacturing hydrogen through a reaction of methane and carbon dioxide are widely used. In particular, the wet reforming method may be considered a desirable option because it can produce large amounts of hydrogen. The wet reforming method uses nickel (Ni), which is a relatively inexpensive transition metal, as a catalyst, but the catalyst that includes nickel may present a problem in that carbon monoxide (CO) generated during the methane reforming reaction can be adsorbed on a surface thereof, and thus, an activity thereof deteriorates.

As a remedy to the problem caused by the decrease in catalytic activity, a hydrocarbon reforming catalyst additive containing an oxide of an alloy of alkali metal and titanium may be used. However, when such an additive is added, an economic feasibility may decrease due to an additional cost, such as the cost of the additive, or due to the change in reaction conditions, such as temperature, during a steam methane reforming reaction, resulting in a lower methane shift rate.

Accordingly, it is desirable to research and develop a hydrogen manufacturing apparatus, by which it is easy to measure a methane shift rate during a reforming reaction and cope with a decrease in the methane shift rate, and a hydrogen manufacturing method using the same.

### SUMMARY

An aspect of the present disclosure provides a hydrogen manufacturing apparatus that may measure a methane shift rate during a reforming reaction by measuring a temperature of gas discharged from a water gas shift reactor, and may easily cope with a decrease in the methane shift rate to prevent a decrease in hydrogen production efficiency due to a decrease in an activity of a reforming catalyst, and a hydrogen manufacturing method using the same.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus, for manufacturing hydrogen by using a vapor-methane reforming reaction, may include: a reformer configured to generate, through a reaction of methane and water, a first gas. The first gas may include hydrogen and carbon monoxide. The apparatus may further include: a water gas shift reactor configured to generate, through a reaction of the carbon monoxide in the first gas and of water, a second gas; and a processor configured to determine, based on a temperature of the second gas measured by a first temperature sensor, a methane shift rate in the reformer.

The apparatus may further include: a first temperature control device configured to control a temperature of the reformer to adjust a temperature of the second gas.

The apparatus may further include: a temperature measuring and controlling device configured to measure and adjust a temperature of the first gas that is discharged from the reformer, and supply the discharged first gas to the water gas shift reactor.

The apparatus may further include: a flow rate adjuster configured to adjust a flow rate of the water that is supplied to the reformer to adjust the temperature of the second gas.

The apparatus may further include: a second heat exchanger configured to cool and perform gas-liquid separation on the second gas discharged from the water gas shift reactor.

According to one or more example embodiments of the present disclosure, a method, performed by a hydrogen generator, may include: generating, through a first reaction of methane and water, a first gas. The first gas may include hydrogen and carbon monoxide. The method may further include: generating, through a second reaction of the carbon monoxide in the first gas and of water, a second gas; determining, based on a temperature of the second gas measured by a first temperature sensor, a methane shift rate of the first reaction; and controlling, based on the methane shift rate, generation of hydrogen gas.

The method may further include: controlling a temperature of a reformer associated with the first reaction to adjust a temperature of the second gas.

Controlling the temperature of the reformer may include adjusting an amount of heat that is supplied to the first reaction.

The method may further include: measuring and adjusting a temperature of the first gas that is discharged from a reformer associated with the first reaction; and supplying the first gas to a water gas shift reactor associated with the second reaction.

The method may further include: adjusting a flow rate of the water that is supplied to a reformer associated with first reaction.

The method may further include: cooling the second gas; and performing a gas-liquid separation of the second gas.

According to one or more example embodiments of the present disclosure, a hydrogen generator may include: a reformer configured to: receive methane, and generate a first gas. The first gas may include hydrogen and carbon monoxide. The hydrogen generator may further include: a water gas shift reactor configured to: receive the first gas, and generate, through a reaction of the carbon monoxide in the first gas and of water, a second gas. The second gas may include hydrogen and carbon dioxide. The hydrogen generator may further include: a temperature sensor configured to measure a temperature of the generated second gas; a temperature controller configured to adjust an internal temperature of the reformer; and a processor configured to increase, based on the measured temperature of the generated second gas, the internal temperature of the reformer.

The processor may be further configured to determine, based on the measured temperature of the generated second gas, a methane shift rate in the reformer.

The hydrogen generator may further include: a heat exchanger disposed between the reformer and the water gas shift reactor. The first gas output from the reformer may be received by the water gas shift reactor via the heat exchanger.

The heat exchanger may be configured to maintain a temperature of the first gas that is input to water gas shift reactor while the temperature sensor measures the temperature of the generated second gas for a time period.

The processor may be configured to increase the internal temperature of the reformer by increasing, based on a decrease of the measured temperature of the generated second gas, the internal temperature of the reformer.

### BRIEF DESCRIPTION OF THE DRAWINGS

The above and other objects, features and advantages of the present disclosure will be more apparent from the following detailed description taken in conjunction with the accompanying drawings:

FIGS. 1 and 2 are structural diagrams of one or more example hydrogen manufacturing apparatuses;

FIG. 3 is a graph showing a correlation between flow rates of gases in a reformer, temperatures at an outlet of a water gas shift reactor, and methane shift rates;

FIGS. 4, 5, 6, 7, 8, 9, 10, 11, and 12 are structural diagrams of one or more example hydrogen manufacturing apparatuses; and

FIG. 13 is structural diagram of one example hydrogen manufacturing apparatuses.

### DETAILED DESCRIPTION

The present disclosure is described in detail below.

When a component, apparatus, equipment, device, element, or the like of the present disclosure is described as having a purpose or performing an operation, function, or the like, the component, device, or element should be considered herein as being “configured to” meet that purpose or perform that operation or function.

Herein, when a certain portion “includes” a certain component, this means that the certain portion may further include other components without excluding said other components unless otherwise stated.

Herein, when a first member is located on a “surface”, “one surface”, “the other surface” or “both surfaces” of a second member, this includes not only a case in which the first member is in contact with the second member, but also a case in which a third member exists between the two members.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless specifically stated or apparent from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

### Hydrogen Manufacturing Apparatus

A hydrogen manufacturing apparatus according to the present disclosure may include a reformer, a water gas shift reactor, and a processor.

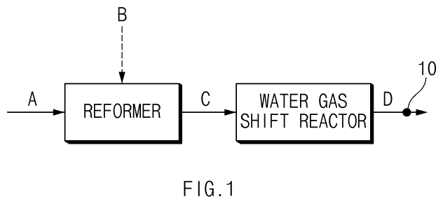

Referring to FIG. 1, an example hydrogen manufacturing apparatus according to the present disclosure may be supplied with methane “A” and water “B”, and may include a reformer, a water gas shift reactor, and a first temperature sensor 10. A first gas “C” that is discharged from the reformer may include hydrogen (H₂) and carbon monoxide (CO). A second gas “D” that is discharged from the water gas shift reactor may include carbon dioxide (CO₂) and hydrogen (H₂).

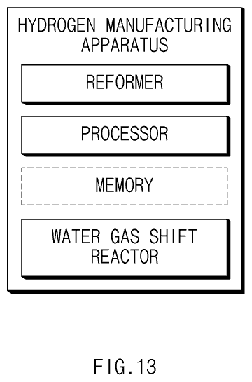

Referring to FIG. 13, example hydrogen manufacturing apparatus according to the present disclosure may include a reformer, a processor, a memory and a water gas shift reactor.

In the reformer, a steam methane reforming (SMR) reaction (e.g., CH₄+H₂O→3H₂+CO, an endothermic reaction), in which methane and water react with each other, may be performed. In the water gas shift reactor, a water-gas shift (WGS) reaction (e.g., CO+H₂O→CO₂+H₂, an exothermic reaction) may be performed. If a methane shift rate (also referred to as a methane conversion rate) in the reformer decreases, the concentration of methane in the first gas “C” discharged from the reformer may increase, and the concentrations of hydrogen and carbon monoxide may decrease. This decrease in the concentration of carbon monoxide in the first gas may lead to a decrease in a water-gas shift reaction rate in the water gas shift reactor, and this may lead to a decrease in the temperature of the second gas “D” discharged from the water gas shift reactor. Accordingly, in the hydrogen manufacturing apparatus according to the present disclosure, a methane shift rate in the reformer may be measured (e.g., determined) by measuring, with the first temperature sensor 10, a temperature of the second gas “D” discharged from the water gas shift reactor.

### Reformer

In the reformer, methane and water may react with each other to generate a first gas. The first gas may include hydrogen and carbon monoxide. As shown in FIG. 1, methane “A” and water “B” may be supplied to the reformer, and a steam methane reforming (SMR) reaction (e.g., CH₄+H₂O→3H₂+CO) as described herein may be performed to generate the first gas “C”. The first gas “C” may include hydrogen and carbon monoxide.

The water “B” supplied to the reformer may be ultrapure water.

The water supplied to the reformer may be pressurized when being supplied, and a compression pump may be used for this purpose. A target pressure may be, for example, 10 bar or less, 9 bar or less, 4 bar or more, or 6 bar or more, but is not limited thereto.

The water supplied to the reformer may be greater in amount than the water that is used for the SMR in the reformer and the amount of water that is used for the WGS in the water gas shift reactor. That is, when the number of moles of methane is set to 1, the water of 1.8 moles or more, 1.9 moles or more, 2.0 moles or more, 2.3 moles or more, 6.0 moles or less, 5.5 moles or less, 5.0 moles or less, or 4.5 moles or less may be supplied to the reformer.

The water provided to the reformer may be larger than the water that is required for the steam methane reforming reaction and the water-gas shift reaction, and thus, the second gas discharged from the water gas shift reactor may include water.

Because the steam methane reforming reaction as described above is an endothermic reaction, the example hydrogen manufacturing apparatus may further include a heat source for supplying heat required for the reaction in the reformer. The heat source may be used with no particular limitation as long as it is generally used as a heat source during an endothermic reaction. For example, the heat source may be a burner and a heat exchanger.

The reformer may include a catalyst for a steam methane reforming reaction. The catalyst for the steam methane reforming reaction is commonly used for reforming reactions, and may be used with no particular limitation as long as it may be manufactured and/or purchased.

Methane supplied to the reformer may be from city gas (e.g., natural gas), but is not limited thereto. The methane may be pressurized and supplied to the reformer, and a gas compressor may be used for this purpose. A target pressure may be, for example, 10 bar or less, 9 bar or less, 4 bar or more, or 6 bar or more, but is not limited thereto.

### First Temperature Control Device

The catalyst for the steam methane reforming reaction may decrease its activity due to cocking or the like, and thus, a methane shift rate in the reformer may be decreased. The decrease in the methane shift rate due to the decrease in the activity of the catalyst may be solved by adjusting the temperature of the reformer. To this end, the hydrogen manufacturing apparatus according to the present disclosure may include a first temperature control device that controls the temperature of the reformer to adjust the temperature of the second gas.

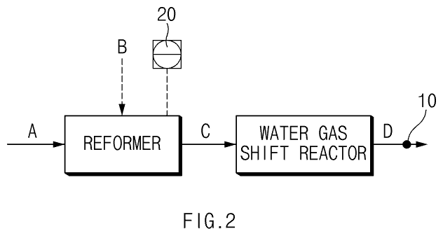

Referring to FIG. 2, an example hydrogen manufacturing apparatus according to the present disclosure may include a first temperature control device 20 for controlling the temperature of the reformer to adjust the temperature of the second gas “D”. It is possible to measure a change in the methane shift rate in the reformer through the temperature of the second gas “D”, which is measured by the first temperature sensor 10. When the temperature of the second gas “D” is lowered, the temperature of the reformer is increased through the first temperature control device 20, so that the methane shift rate may be improved (e.g., increased) by increasing the steam methane reforming reaction rate, and thus, the temperature of the second gas may be improved (e.g., increased).

For example, the temperature control of the reformer may be performed by adjusting an amount of heat that is supplied to the reformer.

The hydrogen manufacturing apparatus may include a temperature measuring and controlling device that measures and adjusts the temperature of the first gas discharged from the reformer and supplies the first gas to the water gas shift reactor.

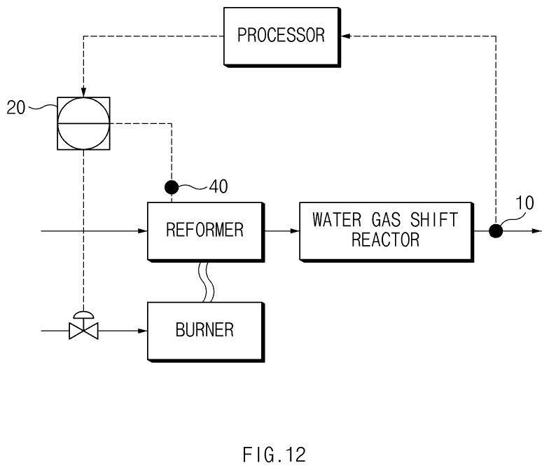

Referring to FIG. 12, an example hydrogen manufacturing apparatus according to the present disclosure may include a first temperature sensor 10, the processor, the first temperature control device 20, and a second temperature sensor 40. The first temperature sensor 10 may measure the temperature of the second gas, the processor may configure to determine, based on a temperature of the second gas measured by a first temperature sensor, a methane shift rate in the reformer. The second temperature sensor 40 may measure the temperature of the reformer, the first temperature control device 20 may control the temperature of the reformer, performed by using burner and the second temperature sensor 40.

### Temperature Measuring and Controlling Device

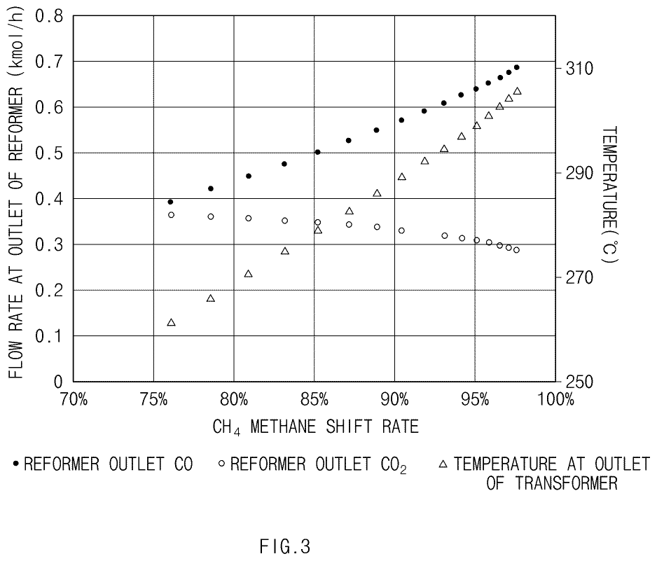

The temperature measuring and controlling device may adjust the temperature of an inlet of the water gas shift reactor by measuring and adjusting the temperature of the first gas and supplying the first gas to the water gas shift reactor. Accordingly, the hydrogen manufacturing apparatus may measure a degree of heat emission due to the water-gas shift reaction in the water gas shift reactor, that is, a change in the methane shift rate in the reformer through measurement of a change in the temperature of the second gas. Example relationships between the methane shift rate, the temperature of the second gas, and the flow rates of CO and CO₂ at the outlet of the reformer are shown in FIG. 3.

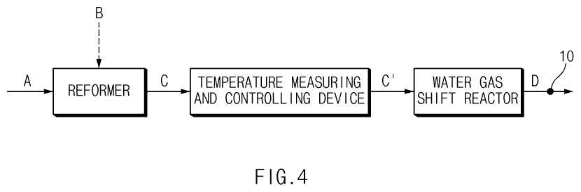

As shown in FIG. 4, an example hydrogen manufacturing apparatus according to the present disclosure may include a temperature measuring and controlling device that measures and adjusts the temperature of the first gas “C” and supplies the temperature-adjusted first gas “C′” to the water gas shift reactor.

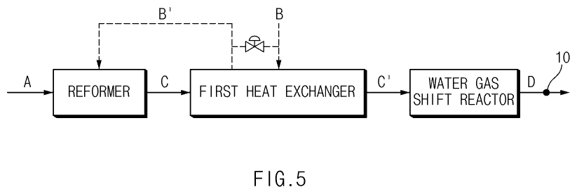

The temperature measuring and controlling device may include a first heat exchanger and a valve. Specifically, in the first heat exchanger, the temperature of the first gas may be adjusted through heat exchange between the water supplied to the reformer and the first gas. As shown in FIG. 5, an example hydrogen manufacturing apparatus according to the present disclosure may include a first heat exchanger that controls the temperature of the first gas through heat exchange between the water “B” supplied to the reformer (e.g., as water “B′”) and the first gas “C”, and a valve that controls whether the water “B” is supplied to the first heat exchanger and also controls a flow rate of the water “B” being supplied to the first heat exchanger. The water “B′” is preheated in first heat exchanger and supplied to the reformer, and temperature of the water “B′” is higher than the water “B”. The temperature of the reformer is increased through the water “B′”, so that the methane shift rate may be improved (e.g., increased) by increasing the steam methane reforming reaction rate.

### Water Gas Shift Reactor

The water gas shift reactor may generate a second gas through a reaction of carbon monoxide in the first gas and water in the first gas. The second gas may include hydrogen and carbon dioxide.

The reaction in the water gas shift reactor may be a water-gas shift (WGS) reaction (e.g., CO+H₂O→CO₂+H₂).

The water gas shift reactor may include a WGS catalyst that promotes a water-gas shift (WGS) reaction. The WGS catalyst is commonly used for the WGS, and may be used with no special limitation as long as it may be manufactured and/or purchased.

The hydrogen manufacturing apparatus may include a flow rate adjuster that adjusts a flow rate of the water supplied to the reformer to adjust the temperature of the second gas.

### Flow Rate Adjuster

The catalyst for the steam methane reforming reaction may decrease its activity due to cocking or the like, and thus, a methane shift rate in the reformer may be decreased. The decrease in the methane shift rate due to the decrease in the activity of the catalyst may be solved by adjusting the flow rate of the water supplied to the reformer. The hydrogen manufacturing apparatus according to the present disclosure may include a flow rate adjuster that adjusts a flow rate of the water supplied to the reformer to adjust the temperature of the second gas.

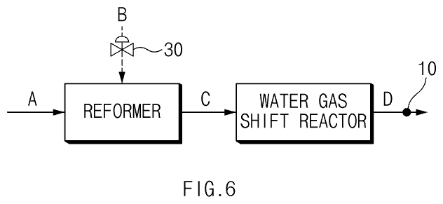

As shown in FIG. 6, an example hydrogen manufacturing apparatus according to the present disclosure may include a flow rate adjuster 30 that adjusts a flow rate of the water “B”, which is a reactant supplied to the reformer to adjust the temperature of the second gas “D”. It is possible to measure a change in the methane shift rate in the reformer through the temperature of the second gas “D”, which is measured by the first temperature sensor 10. If the temperature of the second gas “D” is lowered, the methane shift rate and/or a shift amount may be improved (e.g., increased) by increasing the flow rate of the water supplied to the reformer through the flow rate adjuster 30 to increase a stream methane reforming reaction rate and/or a reaction amount, and thus, the temperature of the second gas may be improved (e.g., increased).

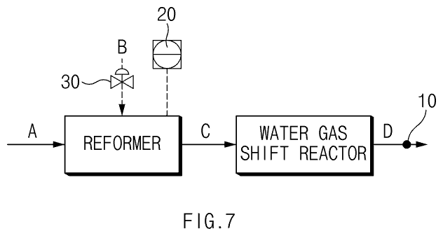

As shown in FIG. 7, an example hydrogen manufacturing apparatus according to the present disclosure may include a first temperature control device 20 that controls the temperature of the reformer to adjust the temperature of the second gas, and a flow rate adjuster 30 that adjusts the flow rate of the water supplied to the reformer.

For example, if the hydrogen manufacturing apparatus includes a first temperature control device 20 that controls the temperature of the reformer to adjust the temperature of the second gas “D” and a flow rate adjuster 30 that adjusts the flow rate of the water supplied to the reformer, the temperature of the reformer may be increased by using the first temperature control device 20 and then, the flow rate of the water supplied to the reformer may be increased by using the flow rate adjuster 30. Specifically, even though the temperature of the reformer is increased by using the first temperature control device 20, a target temperature of the second gas may be reached by increasing the flow rate of the water supplied to the reformer by using the flow rate adjuster 30 when the temperature of the second gas does not reach the target temperature.

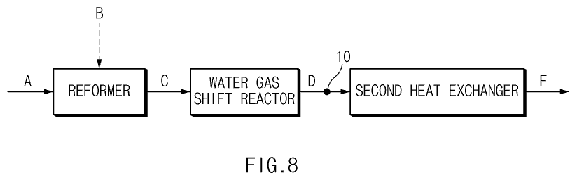

As shown in FIG. 8, an example hydrogen manufacturing apparatus may include a second heat exchanger that cools and performs gas-liquid separation of the second gas.

### Second Heat Exchanger

The second heat exchanger may cool and perform gas-liquid separation of the second gas discharged from the water gas shift reactor. The gas-liquid separation may refer to a process of separating, for example, water and carbon dioxide from each other.

The cooling may be performed at a room temperature, for example, 15° C. or more, 18° C. or more, 20° C. or more, 30° C. or less, 28° C. or less, or 25° C. or less, but the target temperature is not limited thereto.

Through cooling in the second heat exchanger, gas-liquid separation may be performed on the second gas to separate it into liquid water and gaseous hydrogen and/or carbon dioxide. In the second heat exchanger, a third gas, which includes liquid water in the second gas and gaseous hydrogen and/or carbon dioxide in the second gas, may be separated.

For example, the water discharged from the second heat exchanger may be a liquid, and the temperature thereof may be a room temperature, for example, 15° C. or more, 18° C. or more, 20° C. or more, 30° C. or less, 28° C. or less, or 25° C. or less.

As shown in FIG. 8, an example hydrogen manufacturing apparatus according to the present disclosure may include a second heat exchanger that cools and performs gas-liquid separation of the second gas “D” discharged from the water gas shift reactor. A third gas “F” discharged from the second heat exchanger may include hydrogen and carbon dioxide. The third gas “F” may not include water.

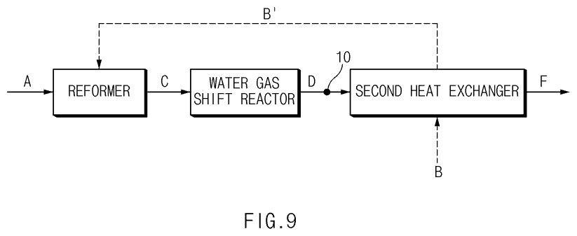

As shown in FIG. 9, the water “B” and the second gas “D” supplied to the reformer may exchange heat in the second heat exchanger. Specifically, in the second heat exchanger, the water “B” supplied to the reformer (e.g., as water “B′”) may be preheated, and the second gas “D” may be cooled. The water “B′” is preheated in second heat exchanger and supplied to the reformer, and temperature of the water “B′” is higher than the water “B”. The temperature of the reformer is increased through the water “B′”, so that the methane shift rate may be improved (e.g., increased) by increasing the steam methane reforming reaction rate.

The hydrogen manufacturing apparatus according to the present disclosure may include an adsorption device that for separates and purifies hydrogen from the second gas discharged from the water gas shift reactor.

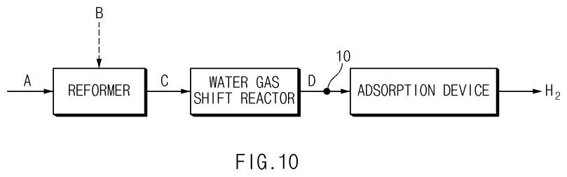

As shown in FIG. 10, an example hydrogen manufacturing apparatus according to the present disclosure may include an adsorption device that produces hydrogen by separating and purifying the second gas “D” discharged from the water gas shift reactor.

### Adsorption Device

The adsorption device may separate, adsorb, and/or purify hydrogen gas from the second gas and discharge it. The adsorption device may separate the second gas discharged from the water gas shift reactor into hydrogen gas and carbon dioxide through adsorption.

The adsorption device may be any adsorption device that is capable of separating and purifying hydrogen gas from mixed gases. The adsorption device may be used with no particular limitation, and for example, it may be performed by pressure swing adsorption (PSA).

The adsorption device may include a plurality of adsorption towers, or three or more and twelve or less adsorption towers, and the adsorption towers may be filled with an adsorbent. The adsorbent may be any adsorbent that is suitable for purifying hydrogen gas, and it may be used with no particular limitation. The adsorbent may be, for example, a carbon-based material, or a zeolite-based material. The adsorbent may, for example, include activated carbon, alumino-silicate, pure silicate, titano-silicate, and/or alumino-phosphate.

The hydrogen gas discharged from the adsorption device may have a purity of 99% or more, 99.9% or more, or 99.97% or more, so that it may be used as a raw material for fuel cells with no additional purification.

As an example, the hydrogen manufacturing apparatus may further include a second heat exchanger, which cools and performs gas-liquid separation of the second gas discharged from the water gas shift reactor, and an adsorption device, which separates and purifies hydrogen from the second gas discharged from the second heat exchanger.

For example, the hydrogen manufacturing apparatus may include a temperature measuring and controlling device that measures and adjusts the temperature of the first gas discharged from the reformer and supplies it to the water gas shift reactor; and a first temperature control device that controls the temperature of the reformer to adjust the temperature of the second gas.

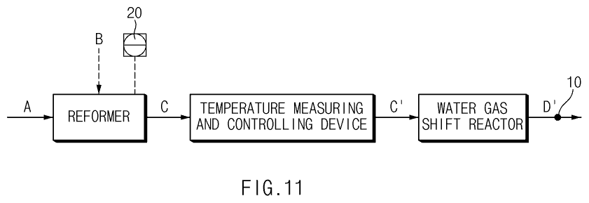

As shown in FIG. 11, an example hydrogen manufacturing apparatus according to the present disclosure may include a reformer that generates a first gas “C” including hydrogen and carbon monoxide through a reaction of methane “A” and water “B”, a temperature measuring and controlling device that measures and adjusts the temperature of the first gas “C” discharged from the reformer and supplies it to the water gas shift reactor, a water gas shift reactor that generates a second gas “D” through a reaction of carbon monoxide in the first gas “C” and water, a first temperature sensor 10 that measures the temperature of the second gas, and a first temperature control device 20 that controls the temperature of the reformer.

The hydrogen manufacturing apparatus may include a control valve that adjusts the flow rate of the water supplied to the reformer and the water gas shift reactor. A reaction rate of the reaction in the reformer may be adjusted by adjusting the flow rate of the water supplied separately to the reformer through the control valve. A reaction rate of the reaction in the water gas shift reactor may be adjusted by adjusting the flow rate of water supplied separately to the water gas shift reactor through the control valve. Accordingly, the hydrogen manufacturing apparatus may have a better hydrogen production yield rate.

As described herein, the hydrogen manufacturing apparatus according to the present disclosure may easily measure the methane shift rate in the reformer by measuring the temperature of the gas discharged from the water gas shift reactor. Furthermore, the hydrogen manufacturing apparatus may prevent a decrease in the hydrogen production yield rate due to a decrease in the activity of the reforming catalyst by controlling the temperature of the reformer.

### Hydrogen Manufacturing Method

The hydrogen manufacturing method according to the present disclosure may include a reforming operation, a transforming operation, and a first temperature measuring operation.

In the hydrogen manufacturing method, the methane shift rate in the reforming operation was measured by measuring the temperature of the second gas discharged in the transforming operation, in the first temperature measuring operation.

### Reforming Operation

In the reforming operation, methane and water react with each other to generate a first gas including hydrogen and carbon monoxide. Referring to FIG. 1, methane “A” and water “B” may be supplied to the reformer, and a steam methane reforming (SMR) reaction (CH₄+H₂O→3H₂+CO) as described above is performed to generate the first gas “C” including hydrogen and carbon monoxide.

The water “B” used in the reforming operation may include ultrapure water.

Because the steam methane reforming reaction as described above is an endothermic reaction, the heat required for the steam methane reforming reaction may be supplied to the reforming operation. The supply of heat as described above may be used with no particular limitation in any conventional method, and for example, a burner, a heat exchanger, or the like may be used.

The temperature in the reforming operation may be, for example, 750° C. or more, 760° C. or more, 780° C. or more, 800° C. or more, 950° C. or less, 940° C. or less, 930° C. or less, 910° C. or less, or 900° C. or less. When the temperature in the reforming operation is within the above range, a sub reaction that causes cocking may be suppressed so that a decrease in the activity of the catalyst may be prevented and the efficiency of the methane reforming reaction may be improved (e.g., increased), and thus, the hydrogen production yield rate may be improved (e.g., increased).

Furthermore, the reforming operation may be performed in the presence of a catalyst for the steam methane reforming reaction. The catalyst for the steam methane reforming reaction may be any catalyst suitable reforming reactions, and may be used with no particular limitation as long as it may be manufactured and/or purchased.

The molar ratio of the methane and the water supplied to the reforming operation may be, for example, 1:0.3 or more and 0.7 or less. When the amount of the water supplied to the reforming operation is within the above range, the yield rate of the methane reforming reaction may be improved (e.g., increased), and the sub reaction that causes cocking may be suppressed by reducing a pyrolysis reaction of the methane, so that a decrease in the activity of the catalyst may be prevented.

### First Temperature Control Operation

The catalyst for the steam methane reforming reaction may decrease its activity due to cocking or the like, and thus, a methane shift rate in the reforming operation may be decreased. The decrease in the methane shift rate due to the decrease in the activity of the catalyst may be solved by adjusting the temperature of the reforming operation. To this end, the hydrogen manufacturing method according to the present disclosure may include a first temperature control operation of that controlling the temperature in the reforming operation to adjust the temperature of the second gas.

As described herein, it is possible to measure a change in the methane shift rate in the reforming operation through the temperature of the second gas, which is measured by the first temperature measuring operation. If the temperature of the second gas is lowered, the temperature in the reforming operation may be increased through the first temperature control operation, so that the methane shift rate may be improved by increasing the steam methane reforming reaction rate, and thus, the temperature of the second gas may be improved (e.g., increased).

For example, the temperature control of the reforming operation as described above may be performed by adjusting an amount of heat that is supplied to the reforming operation. The target temperature of the reforming operation may be within the above-described range in the reforming operation.

The hydrogen manufacturing method may include a temperature measuring and controlling operation of measuring and adjusting the temperature of the first gas discharged in the reforming operation and supplying the first gas to the transforming operation.

### Temperature Measuring and Controlling Operation

The temperature measuring and controlling operation serves to adjust an initial temperature of the transforming operation by measuring and adjusting the temperature of the first gas and supplying the first gas to the transforming operation. Accordingly, according to the hydrogen manufacturing method, a degree of heat emission due to the water-gas shift reaction in the transforming operation, that is, a change in the methane shift rate in the reforming operation may be measured through the measurement of a temperature change of the second gas (see FIG. 3).

As shown in FIGS. 4 and 5, the temperature measuring and controlling operation may be performed by using the first heat exchanger and the valve. Specifically, the first heat exchanger may adjust the temperature of the first gas through heat exchange between the water supplied to the reforming operation and the first gas.

### Transforming Operation

In the transforming operation, a second gas is generated through a reaction of carbon monoxide included in the first gas and water. The second gas may include hydrogen and carbon dioxide.

The reaction in the transforming may be a water-gas shift (WGS) reaction (e.g., CO+H₂O→CO₂+H₂).

Furthermore, the transforming operation may be performed in the presence of a WGS catalyst that promotes a water-gas shift (WGS) reaction, and the WGS catalyst is commonly used for the WGS, and may be used with no special limitation as long as it may be manufactured and/or purchased.

The temperature in the transforming operation may be, for example, 150° C. or more, 180° C. or more, 200° C. or more, 350° C. or less, 320° C. or less, or 300° C. or less. Furthermore, the manufactured second gas may have a temperature of 150° C. or more, 180° C. or more, 200° C. or more, 350° C. or less, 320° C. or less, or 300° C. or less. Accordingly, the second gas may include water in the form of water vapor and gaseous carbon dioxide.

The hydrogen manufacturing method may include a flow rate adjusting operation of controlling a flow rate of the water supplied to the reforming operation to adjust the temperature of the second gas.

### Flow Rate Adjusting Operation

The catalyst for the steam methane reforming reaction may decrease its activity due to cocking or the like, and thus, a methane shift rate in the reforming operation may be decreased. The decrease in the methane shift rate due to the decrease in the activity of the catalyst may be solved by adjusting the flow rate of the water supplied to the reforming operation. To this end, the hydrogen manufacturing method according to the present disclosure may include a flow rate adjusting operation of adjusting a flow rate of the water supplied to the reforming operation to adjust the temperature of the second gas.

As described above, it is possible to measure a change in the methane shift rate in the reforming operation through the temperature of the second gas, which is measured by the first temperature measuring operation. When the temperature of the second gas is lowered, the methane shift rate and/or a shift amount may be improved by increasing the flow rate of the water supplied to the reforming operation through the flow rate adjusting operation to increasing a stream methane reforming reaction rate and/or a reaction amount, and thus, the temperature of the second gas may be improved.

Specifically, the hydrogen manufacturing method according to the present disclosure may include a first temperature control operation of controlling the temperature of the reforming operation to adjust the temperature of the second gas, and a flow rate adjusting operation of adjusting the flow rate of the water supplied to the reforming operation. More specifically, the hydrogen manufacturing method may include a first temperature control operation of controlling the temperature of the reforming operation by adjusting the amount of the heat supplied to the reforming operation and a flow rate adjusting operation of adjusting the flow rate of the water supplied to the reforming operation.

For example, when the hydrogen manufacturing method includes the first temperature control operation of controlling the temperature of the reforming operation to adjust the temperature of the second gas “D”, and the flow rate adjusting operation of adjusting the flow rate of the water supplied to the reformer, the temperature in the reforming operation may be increased through the first temperature control operation and the flow rate of the water supplied to the reforming operation may be increased through the flow rate adjusting operation. Specifically, even though the temperature of the reforming operation is increased by using the first temperature control operation, a target temperature of the second gas may be reached by increasing the flow rate of the water supplied to the reforming operation through the flow rate adjusting operation when the temperature of the second gas does not reach the target temperature.

The hydrogen manufacturing method may include a second heat exchange operation of cooling and performing gas-liquid separation of the second gas.

### Second Heat Exchange Operation

In the second heat exchange operation, the second gas discharged from the transforming operation may be cooled and gas-liquid separation may be performed on the discharged second gas. The gas-liquid separation may be one that separates the water and the carbon dioxide.

The cooling may be performed at a room temperature, for example, 15° C. or more, 18° C. or more, 20° C. or more, 30° C. or less, 28° C. or less, or 25° C. or less, but the target temperature is not limited thereto.

Through cooling in the second heat exchange operation, gas-liquid separation may be performed on the second gas to separate it into liquid water and gaseous carbon dioxide. In detail, in the second heat exchange operation, a third gas including liquid water in the second gas and gaseous hydrogen and/or carbon dioxide in the second gas may be separated.

For example, the water discharged from the second heat exchange operation may be a liquid, and the temperature thereof may be a room temperature, for example, 15° C. or more, 18° C. or more, 20° C. or more, 30° C. or less, 28° C. or less, or 25° C. or less.

The third gas discharged from the second heat exchange operation may include hydrogen and carbon dioxide, and may not include water.

For example, as show in FIG. 9, in the second heat exchange operation, the water “B” and the second gas “D” supplied to the reforming operation may exchange heat. Specifically, in the second heat exchange operation, the water “B” supplied to the reforming operation may be preheated, and the second gas “D” may be cooled.

The hydrogen manufacturing method according to the present disclosure may include an adsorption operation for separating and purifying the second gas discharged from the transforming operation.

### Adsorption Operation

In the adsorption operation, the second gas discharged in the transforming operation may be adsorbed, separated, and purified to emit the hydrogen gas and the carbon dioxide, respectively.

Furthermore, as long as it may be commonly used to adsorb, separate, and purify hydrogen gas from mixed gases, the adsorption operation may be used with no particular limitation, and for example, it may be performed by pressure swing adsorption (PSA).

Furthermore, the hydrogen gas discharged from the adsorption operation has a purity of 99% or more, 99.9% or more, or 99.97% or more, so that it may be used as a raw material for fuel cells with no additional purification.

According to an aspect of the present disclosure, an apparatus for manufacturing hydrogen by using a vapor-methane reforming reaction includes a reformer that generates a first gas including hydrogen and carbon monoxide through a reaction of methane and water, a water gas shift reactor that generates a second gas through carbon monoxide in the first gas and water, and a processor that measures a temperature of the second gas to measure a methane shift rate in the reformer.

According to another aspect of the present disclosure, a method for manufacturing hydrogen by using a vapor-methane reforming reaction includes a reforming operation of generating a first gas including hydrogen and carbon monoxide through a reaction of methane and water, a transforming operation of generating a second gas through carbon monoxide in the first gas and water, and a first temperature measuring operation of measuring a temperature of the second gas to measure a methane shift rate in the reformer.

According to the hydrogen manufacturing method, the methane shift rate in the reforming operation may be easily measured by measuring the temperature of the gas discharged from the transforming operation. Furthermore, according to the hydrogen manufacturing method, a decrease in the hydrogen production yield rate due to a decrease in reforming catalyst activity may be prevented by controlling the temperature of the reforming operation.

What is claimed is:

1. An apparatus for manufacturing hydrogen by using a vapor-methane reforming reaction, the apparatus comprising:
a reformer configured to generate, through a reaction of methane and water, a first gas, wherein the first gas comprises hydrogen and carbon monoxide;
a water gas shift reactor configured to generate, through a reaction of the carbon monoxide in the first gas and of water, a second gas; and
a processor configured to determine, based on a temperature of the second gas measured by a first temperature sensor, a methane shift rate in the reformer.

2. The apparatus of claim 1, further comprising:
a first temperature control device configured to control a temperature of the reformer to adjust a temperature of the second gas.

3. The apparatus of claim 1, further comprising:
a temperature measuring and controlling device configured to measure and adjust a temperature of the first gas that is discharged from the reformer, and supply the discharged first gas to the water gas shift reactor.

4. The apparatus of claim 1, further comprising:
a flow rate adjuster configured to adjust a flow rate of the water that is supplied to the reformer to adjust the temperature of the second gas.

5. The apparatus of claim 1, further comprising:
a second heat exchanger configured to cool and perform gas-liquid separation on the second gas discharged from the water gas shift reactor.

6. A method performed by a hydrogen generator, the method comprising:
generating, through a first reaction of methane and water, a first gas, wherein the first gas comprises hydrogen and carbon monoxide;
generating, through a second reaction of the carbon monoxide in the first gas and of water, a second gas;
determining, based on a temperature of the second gas measured by a first temperature sensor, a methane shift rate of the first reaction; and
controlling, based on the methane shift rate, generation of hydrogen gas.

7. The method of claim 6, further comprising:
controlling a temperature of a reformer associated with the first reaction to adjust a temperature of the second gas.

8. The method of claim 7, wherein the controlling of the temperature of the reformer comprises adjusting an amount of heat that is supplied to the first reaction.

9. The method of claim 6, further comprising:
measuring and adjusting a temperature of the first gas that is discharged from a reformer associated with the first reaction; and
supplying the first gas to a water gas shift reactor associated with the second reaction.

10. The method of claim 6, further comprising:
adjusting a flow rate of the water that is supplied to a reformer associated with first reaction.

11. The method of claim 6, further comprising:
cooling the second gas; and
performing a gas-liquid separation of the second gas.

12. A hydrogen generator comprising:
a reformer configured to:
receive methane; and
generate a first gas, wherein the first gas comprises hydrogen and carbon monoxide;
a water gas shift reactor configured to:
receive the first gas; and
generate, through a reaction of the carbon monoxide in the first gas and of water, a second gas, wherein the second gas comprises hydrogen and carbon dioxide;
a temperature sensor configured to measure a temperature of the generated second gas;
a temperature controller configured to adjust an internal temperature of the reformer; and
a processor configured to increase, based on the measured temperature of the generated second gas, the internal temperature of the reformer.

13. The hydrogen generator of claim 13, wherein the processor is further configured to determine, based on the measured temperature of the generated second gas, a methane shift rate in the reformer.

14. The hydrogen generator of claim 13, further comprising:
a heat exchanger disposed between the reformer and the water gas shift reactor, wherein the first gas output from the reformer is received by the water gas shift reactor via the heat exchanger.

15. The hydrogen generator of claim 14, wherein the heat exchanger is configured to maintain a temperature of the first gas that is input to water gas shift reactor while the temperature sensor measures the temperature of the generated second gas for a time period.

16. The hydrogen generator of claim 13, wherein the processor is configured to increase the internal temperature of the reformer by increasing, based on a decrease of the measured temperature of the generated second gas, the internal temperature of the reformer.
